(19) United States
(12) Patent Application Publication
(10) Pub. No.: US 2023/0296238 A1
(43) Pub. Date: Sep. 21, 2023

(54) Waterproof lamp

(71) Applicant: Shenzhen XiangYu Guang Technology Co., Ltd, Shenzhen (CN)

(72) Inventor: JuQiong Ren, Langzhong (CN)

(21) Appl. No.: 17/654,995

(22) Filed: Mar. 16, 2022

(51) Int. Cl. F21V 31/00; F21V 17/10; F21V 23/00; F21V 25/02

(52) U.S. Cl. CPC F21V 31/005; F21V 17/101; F21V 23/009; F21V 25/02

(57) ABSTRACT

The invention provides a waterproof lamp, which comprises a waterproof lamp body, wherein a switch is arranged on the waterproof lamp body, a waterproof switch structure is arranged at the switch, and the switch is arranged in an inner cavity of the waterproof switch structure; the invention also relates to a working method for the waterproof lamp. The waterproof lamp is provided with the waterproof switch structure at the switch, the waterproof switch structure comprises a waterproof sleeve and a fixing sleeve, and the structures and connection mode of the waterproof sleeve, the fixing sleeve and the waterproof lamp body ensure the sealing of the waterproof lamp at the switch, so that the waterproof lamp can be used underwater for a long time; the working method of the waterproof lamp can avoid oxidation and rusting when the waterproof lamp is used underwater, and prolong its service life.

### TECHNICAL FIELD

The invention relates to the lamp field, in particular to a waterproof lamp.

### BACKGROUND ART

At present, underwater lamps are mostly used in swimming pools, fish tanks and other occasions. The existing underwater lamps are prone to water leakage, electric leakage and short circuit due to sealing problem, thus affecting the use effect of underwater lamps.

The underwater lamps on the market are generally rechargeable. The charging device for the existing underwater lamps generally adopts the magnetic structure, which charges underwater. When the magnetic structure is used for a long time, the magnet easily absorbs foreign matters at the interface, resulting in the defects of oxidation and short circuit.

In addition, the charging socket for the existing underwater lamps is always in charged state, so the charging socket has fast electrolytic oxidation speed and short service life.

Therefore, it is necessary to provide a waterproof lamp to solve the above technical problems.

### SUMMARY OF THE INVENTION

The invention provides a waterproof lamp to solve the problems of electric leakage, short circuit and easy oxidation of underwater lamps existing in the prior art.

To solve the above technical problems, the invention adopts the following technical proposal: a waterproof lamp comprises a waterproof lamp body, wherein a switch is arranged on the waterproof lamp body, a waterproof switch structure is arranged at the switch, and the switch is arranged in an inner cavity of the waterproof switch structure.

In the waterproof lamp of the invention, the waterproof switch structure comprises a waterproof sleeve and a fixing sleeve, the waterproof sleeve is connected with the fixing sleeve, and a fixing part is arranged at the connection between the fixing sleeve and the waterproof sleeve and encircles the connection between the fixing sleeve and the waterproof sleeve.

In the waterproof lamp of the invention, the waterproof sleeve is connected with the waterproof lamp body, a first connecting part is arranged on the waterproof sleeve, a second connecting part is arranged on the waterproof lamp body, the first connecting part and the second connecting part are connected together, the first connecting part is an inverted edge, the second connecting part is a groove, and the inverted edge is matched with the groove.

In the waterproof lamp of the invention, a charging socket, a rechargeable battery and a safety switch electrically connected between the charging socket and the rechargeable battery are arranged on the waterproof lamp body, and the charging socket, the safety switch and the rechargeable battery are connected in series.

In the waterproof lamp of the invention, the charging socket is connected in parallel with a discharge resistor.

In the waterproof lamp of the invention, the charging socket comprises a shell, a central column and a sealing plug for hermetically sealing the shell, wherein the central column is inserted in the inner cavity of the shell, and the sealing plug can be detachably sealed on the shell.

In the waterproof lamp of the invention, a ring cavity, a first connecting channel for connecting the ring cavity to the inner cavity of the shell and a second connecting channel for connecting the ring cavity to the outside are formed on the shell, the waterproof lamp also comprises a first one-way gas flow valve installed in the first connecting channel, a second one-way gas flow valve installed in the second connecting channel and a heating body used for heating the shell, the water vapor in the inner cavity can flow to the ring cavity through the first one-way gas flow valve, and the water vapor in the ring cavity can flow to the outside through the second one-way gas flow valve.

In the waterproof lamp of the invention, the heating body is a resistive heater surrounding the shell and is connected in parallel with the rechargeable battery, and a control switch is connected between the heating body and the rechargeable battery, and the control switch is turned on when the charging socket is connected to the external charging device and the concentration of water vapor existing in the inner cavity is beyond the preset value; the safety switch is turned on and the control switch is turned off when the concentration of water vapor existing in the inner cavity is lower than the preset value.

In the waterproof lamp of the invention, the sealing plug is made of POM material, the shell and the central column are made of copper, and the surfaces of the shell and the central column are respectively electroplated with a bright nickel layer, and the inner wall of the ring cavity is electroplated with the bright nickel layer.

In the waterproof lamp of the invention, the waterproof lamp body comprises a surface shell and a bottom shell, wherein the surface shell and the bottom shell are spliced together by the ultrasonic process, ultrasonic lines are arranged on the splicing surfaces of the surface shell and the bottom shell, and the ultrasonic line on the splicing surface of the surface shell is matched with that on the splicing surface of the bottom shell.

Compared with the prior art, the invention has the following beneficial effects:

1. The waterproof lamp is provided with a waterproof switch structure, which comprises a waterproof sleeve and a fixing sleeve, and the structures and connection mode of the waterproof sleeve, the fixing sleeve and the waterproof lamp body ensure the sealing of the waterproof lamp at the switch and ensure that the waterproof lamp is watertight and leakproof, so that the waterproof lamp can be used underwater for a long time;

2. The waterproof lamp is provided with a charging socket with a waterproof structure to prevent electric or water leakage, and the material of the charging socket ensures the waterproofness of the charging socket and prevents the charging socket from being oxidized and getting rusty in water, so that the waterproof lamp can be charged underwater for a long time and free from water leakage, electric leakage and short circuit.

3. The waterproof lamp is provided with a safety switch, which can be turned on in uncharged state to prevent water from being electrolyzed by the current in the rechargeable battery flowing to the charging socket, resulting in the oxidation of the charging socket.

4. The waterproof lamp is provided with a discharge resistor, through which the current remaining on the charging socket can be depleted at the moment when the charging socket is disconnected from the external charging device, so as to prevent water from being electrolyzed by the charging socket, resulting in the oxidation of the charging socket.

5. The waterproof lamp is provided with a heating body, through which water that will enter the inner cavity of the shell when the charging socket is connected to the external device underwater can be heated into water vapor and flows to the ring cavity through the first one-way gas flow valve and then to the outside through the second one-way gas flow valve, so as to avoid the oxidation of the charging socket when the moisture inside the inner cavity of the shell is electrolyzed. Specifically, the safety switch is turned off only when the moisture concentration in the inner cavity is lower than the preset value, so that the moisture can be removed through the heating body when the moisture concentration in the inner cavity is higher than the preset value, so as to ensure that there is no water electrolyzed in the inner cavity of the shell when the external charging device charges the rechargeable battery.

6. In the waterproof lamp, the surface shell and the bottom shell are connected by the ultrasonic technology, so as to ensure the sealing between the surface shell and the bottom shell.

### DESCRIPTION OF THE DRAWINGS

In order to more clearly explain the embodiments of the invention or the technical proposal of the prior art, the drawings required in the embodiments are briefly introduced below. The drawings described below are only corresponding drawings for some embodiments of the invention.

FIG. 1 is the exploded view for the waterproof lamp of the invention.

FIG. 2 is the structure diagram of the surface shell for the waterproof lamp of the invention.

FIG. 3 is the structure diagram of the waterproof lamp with a toggle switch in the embodiment 1 of the invention.

FIG. 4 is the structure diagram of the waterproof lamp with a touch switch in the embodiment 2 of the invention.

FIG. 5 is the connection diagram of the waterproof switch structure for the waterproof lamp of the invention.

FIG. 6 is the exploded view of the waterproof switch structure for the waterproof lamp of the invention.

FIG. 7 is the connection diagram of the waterproof sleeve for the waterproof lamp of the invention.

FIG. 8 is the section view of the charging socket for the waterproof lamp of the invention.

FIG. 9 the partial enlarged diagram at A in FIG. 8.

FIG. 10 is the connection diagram of the surface shell and the reflection lampshade for the waterproof lamp of the invention.

FIG. 11 is the structure diagram of the ultrasonic line for the waterproof lamp of the invention.

FIG. 12 is the overall structure diagram for the waterproof lamp of the invention.

FIG. 13 is the internal structure diagram for the waterproof lamp of the invention.

FIG. 14 is the top view for the waterproof lamp of the invention.

FIG. 15 is the structure diagram of the charging plug matched with the charging socket of the invention.

FIG. 16 is the circuit diagram of the waterproof lamp in the embodiment 1 of the invention.

FIG. 17 is the circuit diagram of the waterproof lamp in the embodiment 2 of the invention.

FIG. 18 is the circuit diagram of the waterproof lamp in the embodiment 3 of the invention.

Wherein,
1—Waterproof lamp body, 101—Groove, 102—Mounting hole; 103—Surface shell, 104—Bottom shell, 105—Ultrasonic line;
2—Waterproof switch structure, 201—Waterproof sleeve, 2011—Inverted edge, 202—Fixing sleeve, 2021—Fixing part;
3—Lamp body;
4—Toggle switch;
5—Touch switch;
6—Charging socket, 61—Shell, 62—Central column; 601—Inner cavity; 602—Ring cavity; 603—First connecting channel; 604—Second connecting channel; 605—Third connecting channel; 606—Mounting cavity; 607—Buffer cavity;
7—Rechargeable battery;
8—Mounting rack;
9—Hook;
10—Reflection lampshade;
11—Lamp body control panel;
12—Switch circuit board;
13—Foam rubber;
14—Screw;
15—Wire;
16—Charging plug;
17—Heating body;
18—Electromagnet;
19—Permanent magnet.

### EMBODIMENTS

The technical proposal in the embodiments of the invention is clearly and completely described below according to the drawings in the embodiments of the invention. Obviously, the described embodiments are only part of the embodiments of the invention, not all embodiments. Based on the embodiments of the invention, all other embodiments obtained by the technicians in the field without creative labor fall within the scope of protection of the invention.

The direction words mentioned in the invention, such as up, down, front, back, left, right, inner, outer, side, top and bottom, are only directions in the drawings, which are used to explain and understand the invention, not used to limit the invention.

First, second and other terms in the invention are for descriptive purposes only and are not to be understood as indication or implication of relative importance or limitations on the sequence.

In the invention, unless otherwise expressly specified and limited, mounting, connecting, connection, fixing and other terms shall be interpreted broadly, for example, fixed connection, detachable connection or integrating; mechanical or electrical connection; direct connection or indirect connection through an intermediate medium or connection in two components or interaction of two components. For ordinary technicians in the field, the specific meanings of the above terms in the invention can be understood according to the specific circumstances.

The underwater lamps in the prior art are prone to oxidation, water leakage and short circuit.

The following describes a waterproof lamp for solving the above technical problems provided by the invention and the preferred embodiments of its working method.

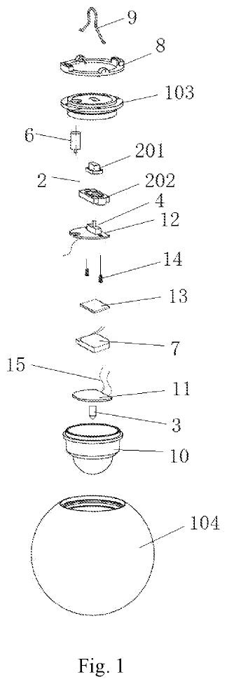

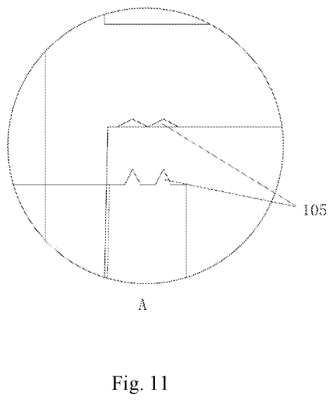

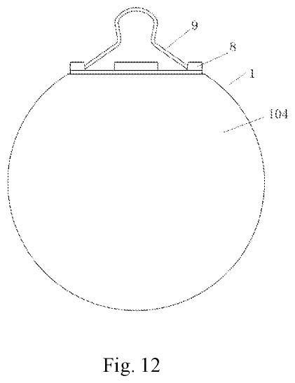

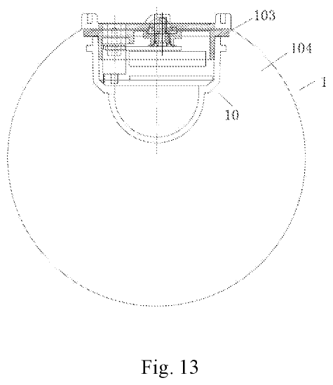

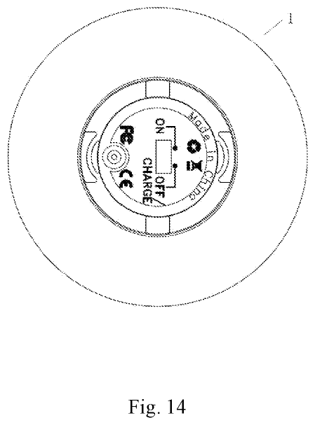

Please refer to FIG. 1-FIG. 18. The invention provides a waterproof lamp mainly used underwater, which comprises a waterproof lamp body 1, wherein a switch is arranged on the waterproof lamp body 1, a waterproof switch structure 2 is arranged at the switch, and the switch is arranged in an inner cavity of the waterproof switch structure 2.

Generally speaking, a lamp body 3 is arranged on the waterproof lamp body 1, and the switch and the lamp body 3 are electrically connected together. Understandably, the switch and the lamp body 3 are connected together through a wire 15, and a connected or disconnected circuit can be formed among the switch, the lamp body 3 and the wire 15.

Generally speaking, the switch controls the lamp body 3 to be turned on or off. Of course, the switch can also be used to control other components of the waterproof lamp to be turned on or off. It depends on the actual situation, and is not limited to that.

It is understandable that the lamp body 3 can be a lamp tube, lamp bead, lamp strip or lamp panel, which depends on the actual situation and is not limited to that.

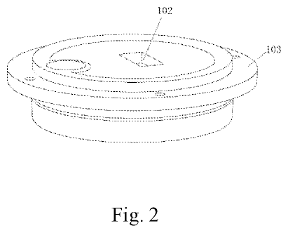

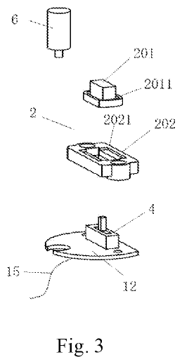

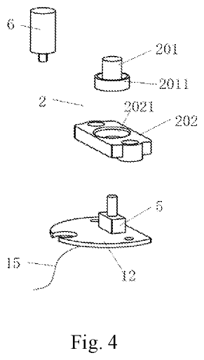

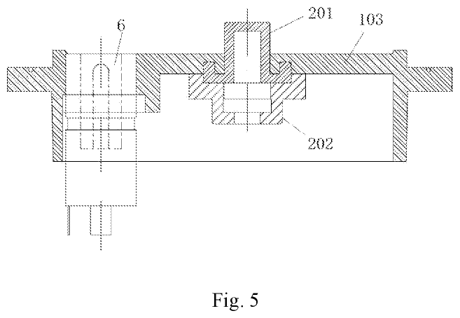

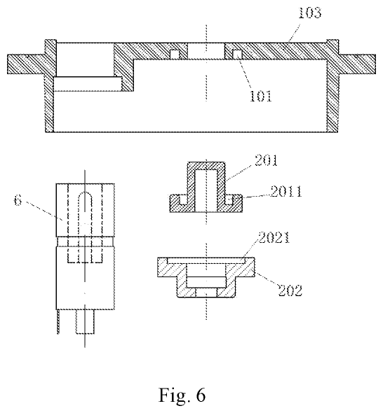

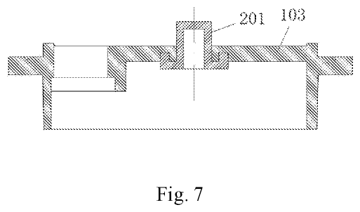

Please refer to FIG. 2-FIG. 7, wherein FIG. 2 is the structure diagram of the surface shell for the waterproof lamp of the invention, FIG. 3 is the structure diagram of the waterproof lamp with a toggle switch in the embodiment 1 of the invention, FIG. 4 is the structure diagram of the waterproof lamp with a touch switch 5 in the embodiment 2 of the invention, FIG. 5 is the connection diagram of the waterproof switch structure for the waterproof lamp of the invention, FIG. 6 is the exploded view of the waterproof switch structure for the waterproof lamp of the invention, and FIG. 7 is the connection diagram of the waterproof sleeve for the waterproof lamp of the invention.

In a waterproof lamp of the invention, the waterproof switch structure 2 comprises a waterproof sleeve 201 and a fixing sleeve 202, wherein the waterproof sleeve 201 is connected with the fixing sleeve 202, a fixing part 2021 is arranged at the connection between the fixing sleeve 202 and the waterproof sleeve 201 and encircles the connection between the waterproof sleeve 201 and the fixing sleeve 202 to avoid water leakage at the connection of the two and improve the connection sealing between the waterproof sleeve 201 and the fixing sleeve 202.

Preferably, the connection between the waterproof sleeve 201 and the fixing sleeve 202 is arranged in the inner cavity of the waterproof lamp body 1 in order to improve the connection sealing between the waterproof sleeve 201 and the fixing sleeve 202.

Preferably, the waterproof lamp body 1 extends at the end where the waterproof sleeve 201 is far from the connection between the waterproof sleeve 201 and the fixing sleeve 202, and a mounting hole 102 for the extension of the waterproof sleeve 201 is arranged on the waterproof lamp body 1, facilitating the user to operate the waterproof lamp body 1.

Preferably, the switch is arranged in the inner cavity of the waterproof sleeve 201, and the inner cavity of the waterproof sleeve 201 is a variable inner cavity, which provides space for the change of the up, down, left and right positions of the switch. Generally speaking, the waterproof sleeve 201 is made of plastic, rubber or silicone, and the user can trigger the switch through the waterproof sleeve 201.

When the switch is a toggle switch 4, the user applies left or right force to the waterproof sleeve 201 to drive the toggle switch 4 to move left or right. During the process, the waterproof sleeve 201 is deformed only, the installation position of the waterproof sleeve 201 is not changed, thus ensuring the sealing of the waterproof sleeve 201 while triggering the toggle switch 4.

When the switch is a key switch, the user intermittently applies downward force to the waterproof sleeve 201 to drive the key switch to downswing or upswing or intermittently move down and reset. The change form of the key switch depends on the type of key switch 5. During the process, the waterproof sleeve 201 is deformed only, the installation position of the waterproof sleeve 201 is not changed, thus ensuring the sealing of the waterproof sleeve 201 while triggering the key switch 5. Preferably, the key switch is a touch switch 5.

In a waterproof lamp of the invention, the waterproof sleeve 201 is connected with the waterproof lamp body 1, a first connecting part is arranged on the waterproof sleeve 201, a second connecting part is arranged on the waterproof lamp body 1, and the first connecting part is connected with the second connecting part.

Preferably, the connection between the waterproof sleeve 201 and the waterproof lamp body 1 is arranged in the inner cavity of the waterproof lamp body 1 in order to improve the connection sealing between the waterproof sleeve 201 and the waterproof lamp body 1.

In a waterproof lamp of the invention, the first connecting part is an inverted edge 2011, the second connecting part is a groove 101, and the inverted edge 2011 is matched with the groove 101.

It is understandable that the first connecting part and the second connecting part can be flat parts, and are detachably fixed together by screw and nut assemblies or adhesive or welding.

It is understandable that the first connecting part and the second connecting part can be tooth parts, and are detachably fixed together by screw and nut assemblies or adhesive or welding after matching.

It is understandable that at least one of the first connecting part and the second connecting part can be concave-convex part, and are detachably fixed together by screw and nut assemblies or adhesive or welding after matching.

Of course, the first connecting part and the second connecting part can also be connected in other forms to ensure that the connection sealing between the waterproof sleeve 201 and the waterproof lamp body 1, and the connection form is not limited to that.

Preferably, the waterproof sleeve 201 is connected with the waterproof lamp body 1, then the fixing sleeve 202 is connected with the waterproof sleeve 201, and finally the fixing sleeve 202 and the waterproof lamp body 1 are locked together through screws, so as to ensure the sealing of the waterproof switch structure 2.

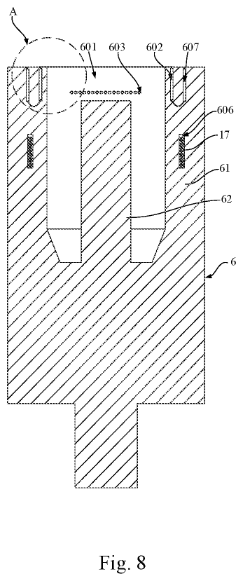

Please refer to FIG. 8, wherein FIG. 8 is the structure diagram of the charging socket for the waterproof lamp of the invention.

In a waterproof lamp of the invention, a charging socket 6 and a rechargeable battery 7 are arranged on the waterproof lamp body 1, and the charging socket 6 is electrically connected with the rechargeable battery 7. It is understandable that the charging socket 6 is electrically connected with the rechargeable battery 7 through a wire 15, and a connected or disconnected circuit can be formed among the charging socket (6), the rechargeable battery (7) and the wire (15).

In a waterproof lamp of the invention, the charging socket 6 is in charged state when the charging socket 6 is connected with the charging device; the charging socket 6 is in uncharged state when the charging socket 6 is disconnected with the charging device, so as to prevent fast electrolytic oxidation because the charging socket 6 is always in charged state and extend the service life of the waterproof lamp underwater or in the humid environment.

In a waterproof lamp of the invention, the charging socket 6 comprises a shell 61, a central column 62 and a sealing plug for hermetically sealing the shell 61, wherein the central column 62 is inserted in the inner cavity 601 of the shell 61, and the sealing plug can be detachably sealed on the shell 61. The external charging device can be plugged into the inner cavity 601 when the sealing plug is opened.

In a waterproof lamp of the invention, the sealing plug is made of POM material, the shell 61 and the central column 62 are made of copper, and the surfaces of the shell 61 and the central column 62 are respectively electroplated with a bright nickel layer to prevent the charging socket 6 from being oxidized and getting rusty in water.

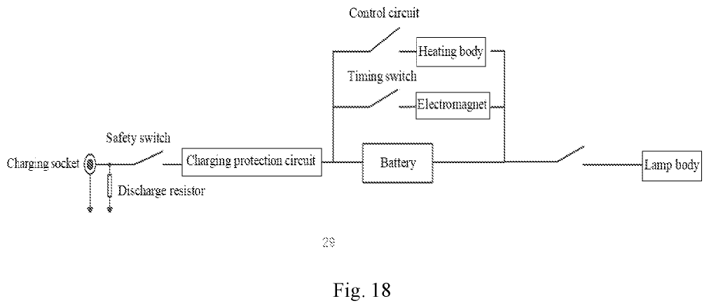

In a waterproof lamp of the invention, a safety switch is electrically connected between the charging socket 6 and the rechargeable battery 7 (as shown in FIG. 18), and the charging socket 6, the safety switch and the rechargeable battery 7 are connected in series. The waterproof lamp is provided with the safety switch, which can be turned on in uncharged state to prevent water from being electrolyzed by the current in the rechargeable battery 7 flowing to the charging socket 6, resulting in the oxidation of the charging socket 6, so that the service life of the waterproof lamp is improved.

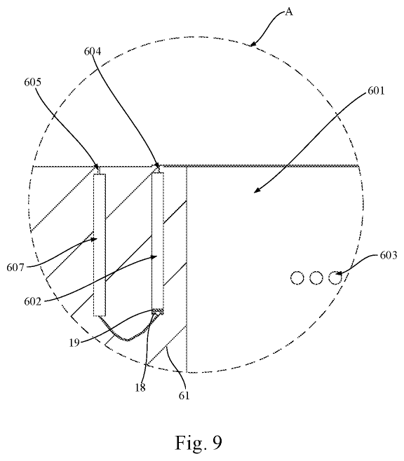

Refer to FIG. 8, FIG. 9 and FIG. 18. A ring cavity 602, a first connecting channel 603 for connecting the ring cavity 602 to the inner cavity 601 of the shell 61 and a second connecting channel 604 for connecting the ring cavity 602 to the outside are formed on the shell 61, the waterproof lamp also comprises a first one-way gas flow valve installed in the first connecting channel 603, a second one-way gas flow valve installed in the second connecting channel 604 and a heating body 17 17 used for heating the shell 61, the water vapor in the inner cavity 601 can flow to the ring cavity 602 through the first one-way gas flow valve, but not flow to the ring cavity 601 through the first one-way gas flow valve, and the water outside cannot flow to the ring cavity 602 through the second one-way gas flow valve. The waterproof lamp is provided with a heating body 17, through which water that will enter the inner cavity 601 of the shell 61 when the charging socket 6 is connected to the external device underwater can be heated into water vapor and flows to the ring cavity 602 through the first one-way gas flow valve and then to the outside through the second one-way gas flow valve, so as to avoid the oxidation of the charging socket 6 when the moisture inside the inner cavity 601 of the shell 61 is electrolyzed. Specifically, the safety switch is turned off only when the moisture concentration in the inner cavity 601 is lower than the preset value, so that the moisture can be removed through the heating body 17 when the moisture concentration in the inner cavity 601 is higher than the preset value, so as to ensure that there is no water electrolyzed in the inner cavity 601 when the external charging device charges the rechargeable battery 7.

Further, in order to further drain off the water in the inner cavity 601 and speed up the removal of water in the inner cavity 601, a buffer cavity 607 and a third connecting channel 605 for connecting the buffer cavity 607 to the outside are formed on the shell 61, a water-resisting exhaust valve is installed in the third connecting channel 605, gas can pass through the water-resisting exhaust valve, but liquid cannot pass through the water-resisting exhaust valve, the ring cavity 602 is provided with a first end connected to the second connecting channel 604 and a second end opposite to the first end, the second end of the ring cavity 602 is connected with the buffer cavity 607 through a pipe, an electromagnet 18 is fixedly arranged at the position close to the second end in the ring cavity 602, a permanent magnet 19 opposite to the electromagnet 18 and a spring connected between the permanent magnet 19 and the first end are also arranged in the ring cavity 602, the electromagnet 18 is electrically connected to the rechargeable battery 7, and a timing switch is connected between the electromagnet 18 and the rechargeable battery 7, the timing switch can be turned on every preset time and then disconnected after the preset time, the spring can drive the permanent magnet 19 to move to the second end when the timing switch is disconnected, the electromagnet 18 is in charged state and repels the permanent magnet 19 to drive the permanent magnet 19 to move to the first end after the timing switch is turned on, and the permanent magnet 19 is closely attached to the inside wall of the ring cavity 602. Furthermore, when the permanent magnet 19 moves to the first end, the pressure in the space between the permanent magnet 19 in the ring cavity 602 and the first end can be increased, so that the gas in the ring cavity 602 flows to the outside from the second one-way gas flow valve to reduce the pressure in the ring cavity 602, and therefore the gas in the inner cavity 601 flows more easily to the ring cavity 602 through the first one-way gas flow valve. When the permanent magnet 19 moves to the second end, the pressure in the space between the permanent magnet 19 in the ring cavity 602 and the second end can be increased, so that the gas in the ring cavity 602 flows to the outside through the buffer cavity 607 and the water-resisting exhaust valve; in addition, the buffer cavity 607 and the water-resisting exhaust valve facilitate the permanent magnet to move to the first end.

It should be noted that the first gas one-way flow valve, the second gas one-way flow valve and the water-resisting exhaust valve are in the prior art, which will not be described here. Of course, they can be new valves that can achieve the same function in the future.

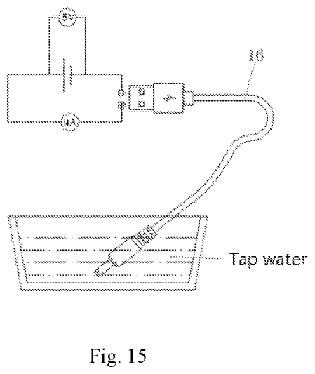

Please refer to FIG. 15, wherein FIG. 15 is the structure diagram of the charging plug matched with the charging socket of the invention.

Preferably, the charging parameter of the waterproof lamp is DC 5V/100 mA, the change value of the measured current is less than +0.2 uA when the waterproof lamp is charged in the water, and the waterproof lamp and the charging device are not overloaded, so that the charging socket 6 and the charging plug 16 cannot be oxidized and get rusty.

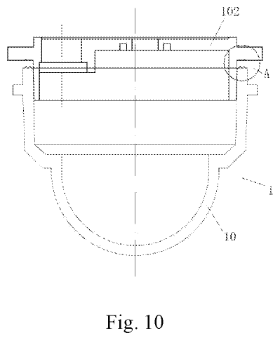

Please refer to FIG. 10-FIG. 14. In a waterproof lamp of the invention, the waterproof lamp body 1 comprises a surface shell 103 and a bottom shell 104, wherein the surface shell 103 and the bottom shell 104 are spliced together by the ultrasonic process, ultrasonic lines 105 are arranged on the splicing surfaces of the surface shell 103 and the bottom shell 104, and the ultrasonic line on the splicing surface of the surface shell 103 is matched with that on the splicing surface of the bottom shell 104.

Preferably, the ultrasonic line 105 is V-shaped or W-shaped, which is conducive to the connection tightness between the surface shell 103 and the bottom shell 104.

Preferably, the ultrasonic process is the ultrasonic bonding process, which depends on the materials of the surface shell 103 and the bottom shell 104.

Preferably, the surface shell 103 and the bottom shell 104 are made of plastic, rubber or silicone, and surface shell 103 and the bottom shell 104 are spliced together by ultrasonic bonding process; the charging socket 6 and the surface shell 103 are integrally molded, that is to say, the charging socket 6 is placed into the forming mold of the surface shell 103 as an insert and is integrally molded with the surface shell 103 by the injection molding process, so as to ensure that the charging socket 6 is firm and waterproof and improve the connection sealing between the charging socket 6 and the surface shell 103.

Preferably, the waterproof sleeve 201 is connected to the surface shell 103, and the mounting hole 102 is arranged on the surface shell 103.

Preferably, a mounting rack 8 is arranged on the waterproof lamp body 1, and a hook 9 is arranged on the mounting rack 8, being conducive to hanging the waterproof lamp.

Preferably, a reflection lampshade 10 is arranged in the waterproof lamp body 1 and is matched with the lamp body 3 to ensure the lighting effect of the waterproof lamp.

Preferably, the surface shell 103 and the reflection lampshade 10 are spliced together by the ultrasonic process, ultrasonic lines 105 are arranged on the splicing surfaces of the surface shell 103 and the reflection lampshade 10, and the ultrasonic line 105 on the splicing surface of the surface shell 103 is matched with that on the splicing surface of the reflection lampshade 10.

Preferably, the ultrasonic line 105 is V-shaped or W-shaped, which is conducive to the connection tightness between the surface shell 103 and the reflection lampshade 10.

Preferably, a lamp body control panel 11 is arranged in the waterproof lamp body 1 and is electrically connected with the lamp body 3.

Preferably, a switch circuit board 12 is arranged in the waterproof lamp body 1 and is electrically connected with the switch.

Generally speaking, foam rubber 13, screws 14 and other parts for fixing the components are also arranged in the waterproof lamp body 1.

Generally speaking, a wire 15 is also arranged in the waterproof lamp body 1, and the components are electrically connected through the wire 15.

Preferably, the lamp body 3, the rechargeable battery 7, the lamp body control panel 11, the switch circuit board 12, the foam rubber 13 and the wire 15 are integrated in the reflection lampshade 10.

Installation process of the invention:

The integrally molded charging socket 6 and surface shell 103 are obtained, the waterproof sleeve 201 is connected with the surface shell 103, the fixing sleeve 202 is connected with the waterproof sleeve 201, and the fixing sleeve 202 is connected with the surface shell 103;

The lamp body 3, the lamp body control panel 11, the rechargeable battery 7, the switch circuit board 12 and the wire 15 are installed in the reflection lampshade 10, the reflection lampshade 10 is installed in the bottom shell 104, and the surface shell 103 is connected with the reflection lampshade 10 and the bottom shell 104;

Finally, the mounting rack 8 and the hook are installed.

The installation process of the waterproof lamp in the preferred embodiment is completed.

The invention provides a working method for a waterproof lamp, including a waterproof lamp in any of the above items. The user triggers the switch by triggering the waterproof switch structure 2.

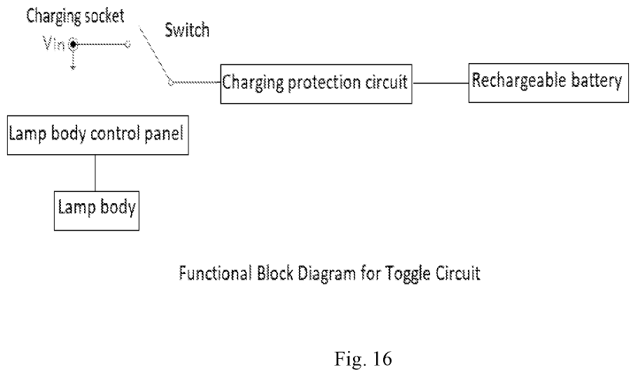

Please refer to FIG. 16, wherein FIG. 16 is the circuit diagram of the waterproof lamp in the embodiment 1 of the invention.

When the switch is the toggle switch 4:

The charging socket 6 is connected in series with the rechargeable battery 7, the lamp body 3 and the lamp body control panel 11 are connected in series with the rechargeable battery 7, and the charging socket 6 is connected in parallel with the lamp body 3 and the lamp body control panel 11; preferably, a charging protection circuit is connected in series between the switch and the rechargeable battery 7.

When the toggle switch 4 moves to the left, the circuit between the charging socket 6 and the rechargeable battery 7 is connected, the charging socket 6 is in charged state, and the charging socket 6 is connected with the charging device through the charging plug 16 to charge the rechargeable battery 7; the circuit among the lamp body 3, the lamp body control panel 11 and the rechargeable battery 7 is disconnected.

When the toggle switch 4 moves to the right, the circuit between the charging socket 6 and the rechargeable battery 7 is disconnected, and the charging socket 6 is separated from the charging device; the circuit among the lamp body 3, the lamp body control panel 11 and the rechargeable battery 7 is connected, and the rechargeable battery 7 supplies power to the lamp body 3.

Therefore, the following can be realized in the circuit through the toggle switch 4: the charging socket 6 is in charged state when the charging socket 6 is connected with the charging device for charging through the charging plug 16; the charging socket 6 is in uncharged state when the charging socket 6 is separated from the charging device, so as to prevent fast electrolytic oxidation because the charging socket 6 is always in charged state and extend the service life of the waterproof lamp underwater or in the humid environment.

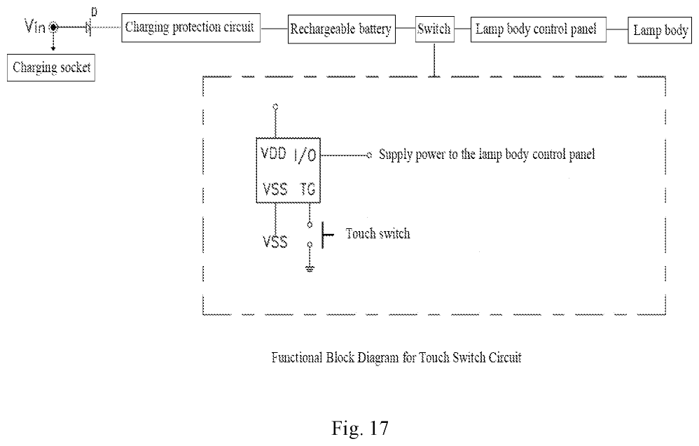

Please refer to FIG. 17, wherein FIG. 17 is the circuit diagram of the waterproof lamp in the embodiment 2 of the invention.

When the switch is the touch switch 5:

The charging socket 6, the rechargeable battery 7, the touch switch 5, the lamp body control panel 11 and the lamp body 3 are connected in series, a diode D and a charging protection circuit are connected in series in a circuit formed by the charging socket 6, the rechargeable battery 7, the touch switch 5, the lamp body control panel 11 and the lamp body 3, the diode D is connected in series between the charging socket 6 and the rechargeable battery 7, and the charging protection circuit is connected in series between the diode D and the rechargeable battery 7; the diode D is unidirectionally conducted, the charging device charges the rechargeable battery 7 through the charging plug 16 and the charging socket 6 when the charging socket 6 is connected with the charging device through the charging plug 16, and the circuit works normally; when the charging device is removed, the charging socket 6 is in uncharged state due to the unidirectional conduction of the diode D.

Therefore, the following can be achieved in the circuit through the diode D: the charging socket 6 is in charged state when the charging socket 6 is connected with the charging device through the charging plug 16; the charging socket 6 is in uncharged state when the charging socket 6 is separated from the charging device, so as to prevent fast electrolytic oxidation because the charging socket 6 is always in charged state and extend the service life of the waterproof lamp underwater or in the humid environment.

The working principle of the touch switch 5 is as follows: the touch switch 5 is controlled by the single chip microcomputer. When the single chip microcomputer receives the instruction of the touch switch 5 for the first time, I/O outputs high level, and the lamp body 3 can work because I/O is directly connected to the positive pole of the lamp body 3; when the single chip microcomputer receives the instruction of the touch switch 5 for the second time, I/O outputs low level, and no power is supplied to the lamp body 3, playing the role of turn-off.

In this way, the lamp body 3 can be turned on and off by triggering the touch switch 5.

Refer to FIG. 18, wherein FIG. 18 is the circuit diagram of the waterproof lamp in the embodiment 3 of the invention.

The charging socket 6 is connected in parallel with a discharge resistor. Because the waterproof lamp is provided with the discharge resistor, the current remaining on the charging socket 6 can be depleted at the moment when the charging socket 6 is disconnected from the external charging device, so as to prevent water from being electrolyzed by the charging socket 6, resulting in the oxidation of the charging socket 6. The charging socket 6, the rechargeable battery 7 and the safety switch electrically connected between the charging socket 6 and the rechargeable battery 7 are arranged on the waterproof lamp body, and the charging socket 6, and are connected in series. The heating body 17 is arranged in parallel with the rechargeable battery 7, and a control switch is connected between the heating body 17 and the rechargeable battery 7. The control switch is turned on when the charging socket 6 is connected to the external charging device and the concentration of water vapor existing in the inner cavity 601 is beyond the preset value; the safety switch is turned on and the control switch is turned off when the concentration of water vapor existing in the inner cavity 601 is lower than the preset value.

In the embodiment, when the waterproof lamp is not charged by the external charging device, both the control switch and the safety switch are disconnected, thus preventing the heating body 17 from consuming the power of the rechargeable battery 7. When the waterproof lamp is required to be charged underwater, the charging cable of the external charging device is firstly inserted into the inner cavity 601 of the shell 61, and water is carried in the inner cavity 601 at this time. Moreover, the control switch is turned on and the safety switch is turned off when the concentration of water in the inner cavity 601 is higher than the preset value (the concentration can be monitored in real time by the sensor). The heating body 17 is energized to heat the shell 61, the shell 61 is heated, the water in the inner cavity 601 evaporates and flows to the ring cavity 602 through the first one-way gas flow valve and then flows to the outside through the second one-way gas flow valve, so as to achieve the purpose of reducing the concentration of water in the inner cavity 601. The safety switch is turned on and the control switch is turned off when the concentration of water in the inner cavity 601 is lower than the preset value, and the external charging device can charge the rechargeable battery 7 at this time. As the water in the inner cavity 601 has been removed, water electrolysis does not occur during charging, so that the charging socket 6 cannot be oxidized, improving the service life of the charging socket 6. When charging is completed, the safety switch is firstly disconnected, and then the external charging device is unplugged from the charging socket 6. As the charging socket 6 has been powered off before the external charging device is unplugged, water electrolysis will not be caused even if the charging socket 6 is in contact with water when being unplugged. Moreover, the current remaining on the charging socket 6 can be depleted through the discharge resistor at the moment when the charging socket 6 is disconnected from the external charging device, so as to prevent water from being electrolyzed by the charging socket 6, resulting in the oxidation of the charging socket 6.

The working process of the waterproof lamp in the preferred embodiment is completed.

To sum up, although the invention has disclosed the waterproof lamp with the preferred embodiments, the preferred embodiments are not intended to limit the invention. Ordinary technicians in the field can make various changes and modifications without deviating from the spirit and scope of the invention. Therefore, the scope of protection of the invention shall be subject to the scope defined by the claims.

I claim:

1. A waterproof lamp, characterized in that the waterproof lamp comprises a waterproof lamp body, wherein a switch is arranged on the waterproof lamp body, a waterproof switch structure is arranged at the switch, and the switch is arranged in an inner cavity of the waterproof switch structure.

2. A waterproof lamp according to claim 1, characterized in that the waterproof switch structure comprises a waterproof sleeve and a fixing sleeve, the waterproof sleeve is connected with the fixing sleeve, and a fixing part is arranged at the connection between the fixing sleeve and the waterproof sleeve and encircles the connection between the fixing sleeve and the waterproof sleeve.

3. A waterproof lamp according to claim 2, characterized in that the waterproof sleeve is connected with the waterproof lamp body, a first connecting part is arranged on the waterproof sleeve, a second connecting part is arranged on the waterproof lamp body, the first connecting part and the second connecting part are connected together, the first connecting part is an inverted edge, the second connecting part is a groove, and the inverted edge is matched with the groove.

4. A waterproof lamp according to claim 1, characterized in that a charging socket, a rechargeable battery and a safety switch electrically connected between the charging socket and the rechargeable battery are arranged on the waterproof lamp body, and the charging socket, the safety switch and the rechargeable battery are connected in series.

5. A waterproof lamp according to claim 4, characterized in that the charging socket is connected in parallel with a discharge resistor.

6. A waterproof lamp according to claim 5, characterized in that the charging socket comprises a shell, a central column and a sealing plug for hermetically sealing the shell, wherein the central column is inserted in the inner cavity of the shell, and the sealing plug can be detachably sealed on the shell.

7. A waterproof lamp according to claim 6, characterized in that a ring cavity, a first connecting channel for connecting the ring cavity to the inner cavity of the shell and a second connecting channel for connecting the ring cavity to the outside are formed on the shell, the waterproof lamp also comprises a first one-way gas flow valve installed in the first connecting channel, a second one-way gas flow valve installed in the second connecting channel and a heating body used for heating the shell, the water vapor in the inner cavity can flow to the ring cavity through the first one-way gas flow valve, and the water vapor in the ring cavity can flow to the outside through the second one-way gas flow valve.

8. A waterproof lamp according to claim 7, characterized in that the heating body is a resistive heater surrounding the shell and is connected in parallel with the rechargeable battery, and a control switch is connected between the heating body and the rechargeable battery, and the control switch is turned on when the charging socket is connected to the external charging device and the concentration of water vapor existing in the inner cavity is beyond the preset value; the safety switch is turned on and the control switch is turned off when the concentration of water vapor existing in the inner cavity is lower than the preset value.

9. A waterproof lamp according to claim 8, characterized in that the sealing plug is made of POM material, the shell and the central column are made of copper, and the surfaces of the shell and the central column are respectively electroplated with a bright nickel layer, and the inner wall of the ring cavity is electroplated with the bright nickel layer.

10. A waterproof lamp according to claim 1, characterized in that the waterproof lamp body comprises a surface shell and a bottom shell, wherein the surface shell and the bottom shell are spliced together by the ultrasonic process, ultrasonic lines are arranged on the splicing surfaces of the surface shell and the bottom shell, and the ultrasonic line on the splicing surface of the surface shell is matched with that on the splicing surface of the bottom shell.
